(19) United States
(12) Patent Application Publication
(10) Pub. No.: US 2025/0172254 A1
(43) Pub. Date: May 29, 2025

(54) MONITORING A PIPING NETWORK

(71) Applicant: Saudi Arabian Oil Company, Dhahran (SA)

(72) Inventors: Mishal M. Alashrah, Dhahran (SA); Abdulsalam I. Alturki, Dhahran (SA)

(21) Appl. No.: 18/519,526

(22) Filed: Nov. 27, 2023

(51) Int. Cl. F17D 5/06; G01N 17/04; G01N 29/12

(52) U.S. Cl. CPC F17D 5/06; G01N 17/04; G01N 29/12; G01N 2291/0234; G01N 2291/0289

(57) ABSTRACT

A pipeline monitoring system includes at least one collar configured to mount on a pipeline that transports a fluid; transducers coupled to the at least one collar and configured to output a plurality of ultrasonic waves that travel through the pipeline; at least one pulse receiver electrically coupled to the plurality of transducers and configured to generate electrical power from a power source; and a control system communicably coupled to the pulse receiver. The control system is configured to perform operations including operating the pulse receiver to transmit the generated electrical power to the transducers to output the ultrasonic waves; receiving, through the transducers, feedback data that includes at least one ultrasonic waveform; and determining, based on the ultrasonic waveform, a location on the pipeline that includes a material anomaly.

### TECHNICAL FIELD

This disclosure relates to systems and methods for monitoring a material of a piping network, such as with a predictive guided wave ultrasonic scanning system to detect material corrosion.

### BACKGROUND

Corrosion, in any type, has always been an overwhelming degradation to the piping system. Corrosion undermines the integrity of the equipment as material deteriorates gradually while being exposed to a corrosive environment. This is a challenge especially in the oil and gas business and thereby efforts to counter such obstacles can be part of a company's strategic objectives.

### SUMMARY

In an example implementation, a pipeline monitoring system includes at least one collar configured to mount on a pipeline that transports a fluid; a plurality of transducers coupled to the at least one collar and configured to output a plurality of ultrasonic waves that travel through the pipeline in at least one direction parallel to a direction of flow of the fluid in the pipeline; at least one pulse receiver electrically coupled to the plurality of transducers and configured to generate electrical power from a power source; and a control system communicably coupled to the pulse receiver. The control system is configured to perform operations including operating the at least one pulse receiver to transmit the generated electrical power to the plurality of transducers to output the plurality of ultrasonic waves; receiving, through the plurality of transducers, feedback data that includes at least one ultrasonic waveform; and determining, based on the at least one ultrasonic waveform, a location on the pipeline that includes a material anomaly.

In an aspect combinable with the example implementation, the at least one collar includes a plurality of collars, each collar configured to mount on the pipeline at a unique location of the pipeline.

In another aspect combinable with any of the previous aspects, the plurality of transducers includes a plurality of sets of transducers, where each set of transducers is coupled to one of the plurality of collars.

In another aspect combinable with any of the previous aspects, each unique location of the pipeline is 50 meters from adjacent unique locations of the pipeline.

In another aspect combinable with any of the previous aspects, the operations include operating the at least one pulse receiver to transmit the generated electrical power to the plurality of sets of transducers to output the plurality of ultrasonic waves; receiving, through the plurality of sets of transducers, feedback data that includes the at least one ultrasonic waveform; and determining, based on the at least one ultrasonic waveform, a plurality of locations on the pipeline that each include a particular material anomaly.

In another aspect combinable with any of the previous aspects, the operations include generating a model of the pipeline that includes the plurality of locations on the pipeline that each include the particular material anomaly; and performing successive iterations over a time duration of: operating the at least one pulse receiver to transmit the generated electrical power to the plurality of sets of transducers to output the plurality of ultrasonic waves; receiving, through the plurality of sets of transducers, feedback data that includes the at least one ultrasonic waveform; and determining, based on the at least one ultrasonic waveform, the plurality of locations on the pipeline that each include the particular material anomaly.

Another aspect combinable with any of the previous aspects includes the operation of updating the model of the pipeline with each successive iteration.

In another aspect combinable with any of the previous aspects, the model includes a machine learning model.

In another aspect combinable with any of the previous aspects, one or more characteristics of the plurality of ultrasonic waves is selected, based on at least one of a pipeline material or a pipeline size, to cause the plurality of ultrasonic waves to travel through the pipeline in the at least one direction parallel to the direction of flow of the fluid in the pipeline.

In another aspect combinable with any of the previous aspects, the one or more characteristics include at least one of amplitude or frequency.

In another aspect combinable with any of the previous aspects, the at least one collar is configured to mount about an outer circumference of the pipeline, and the plurality of transducers are coupled to the least one collar at equally spaced radial intervals about the outer circumference.

In another aspect combinable with any of the previous aspects, the at least one direction parallel to the direction of flow of the fluid in the pipeline includes: a first direction parallel to the direction of flow of the fluid in the pipeline; and a second direction parallel to the direction of flow of the fluid in the pipeline and opposite the first direction.

In another aspect combinable with any of the previous aspects, the material anomaly includes corroded material of the pipeline.

In another aspect combinable with any of the previous aspects, the fluid includes a hydrocarbon fluid.

In another example implementation, a method of monitoring a pipeline material includes operating at least one pulse receiver to transmit electrical power from a power source to a plurality of transducers coupled to at least one collar mounted on a pipeline that transports a fluid; based on the transmitted electrical power from the at least one pulse receiver to the plurality of transducers, outputting a plurality of ultrasonic waves that travel through the pipeline in at least one direction parallel to a direction of flow of the fluid in the pipeline; receiving, through the plurality of transducers, feedback data that includes at least one ultrasonic waveform; and determining, based on the at least one ultrasonic waveform, a location on the pipeline that includes a material anomaly.

An aspect combinable with the example implementation includes operating the at least one pulse receiver to transmit electrical power from the power source to a plurality of sets of transducers, where each set of transducers coupled to a particular collar of a plurality of collars mounted on a pipeline; and based on the transmitted electrical power from the at least one pulse receiver to the plurality of sets of transducers, outputting a plurality of sets of ultrasonic waves that travel through the pipeline in the at least one direction.

Another aspect combinable with any of the previous aspects includes installing each of the plurality of collars on the pipeline at a unique location of the pipeline.

Another aspect combinable with any of the previous aspects includes receiving, through the plurality of sets of transducers, feedback data that includes the at least one ultrasonic waveform; and determining, based on the at least one ultrasonic waveform, a plurality of locations on the pipeline that each include a particular material anomaly.

Another aspect combinable with any of the previous aspects includes generating a model of the pipeline that includes the plurality of locations on the pipeline that each include the particular material anomaly; and performing successive iterations over a time duration of: operating the at least one pulse receiver to transmit the generated electrical power to the plurality of sets of transducers to output the plurality of ultrasonic waves; receiving, through the plurality of sets of transducers, feedback data that includes the at least one ultrasonic waveform; and determining, based on the at least one ultrasonic waveform, the plurality of locations on the pipeline that each include the particular material anomaly.

Another aspect combinable with any of the previous aspects includes updating the model of the pipeline with each successive iteration.

In another aspect combinable with any of the previous aspects, the model includes a machine learning model.

Another aspect combinable with any of the previous aspects includes selecting one or more characteristics of the plurality of ultrasonic waves, based on at least one of a pipeline material or a pipeline size, to cause the plurality of ultrasonic waves to travel through the pipeline in the at least one direction parallel to the direction of flow of the fluid in the pipeline.

In another aspect combinable with any of the previous aspects, the one or more characteristics include at least one of amplitude or frequency.

Another aspect combinable with any of the previous aspects includes mounting the at least one collar about an outer circumference of the pipeline; and connecting the plurality of transducers to the least one collar at equally spaced radial intervals about the outer circumference.

In another aspect combinable with any of the previous aspects, the at least one direction parallel to the direction of flow of the fluid in the pipeline includes a first direction parallel to the direction of flow of the fluid in the pipeline; and a second direction parallel to the direction of flow of the fluid in the pipeline and opposite the first direction.

In another aspect combinable with any of the previous aspects, the material anomaly includes corroded material of the pipeline.

In another aspect combinable with any of the previous aspects, the fluid includes a hydrocarbon fluid.

The details of one or more implementations of the subject matter described in this disclosure are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a schematic illustration of an example implementation of a pipeline monitoring system according to the present disclosure.

FIGS. 2A and 2B are schematic illustrations of the example implementation of a pipeline monitoring system according to the present disclosure.

FIG. 3 is a schematic illustration of a portion of a piping network in which guided ultrasonic waves are propagated to monitor corrosion according to the present disclosure.

FIG. 4 is a schematic illustration of a controller or control system for a pipeline monitoring system according to the present disclosure.

### DETAILED DESCRIPTION

The present disclosure describes example implementations of a pipeline monitoring system that can use guided wave ultrasonic testing to determine one or more material anomalies, such as corrosion, in a piping network (or pipeline). For example, the guided wave ultrasonic testing can be performed iteratively or periodically over time to monitor corrosion or other anomalies of the pipeline in a real time, such as while the pipeline is transporting a fluid (for example, a hydrocarbon fluid) therethrough.

According to example implementations, the guided wave ultrasonic testing applies relatively low frequency ultrasonic waves from one or more collar-transducer assemblies that are mounted at specific locations on the pipeline. The ultrasonic waves can penetrate into and through the wall thickness of the pipeline and propagate across the pipe's longitudinal axis for a certain distance based on the wave intensity. The ultrasonic waves will be interrupted for any surface/subsurface flaws or metal loss in the pipeline; such waves are reflected in waveforms that can be analyzed for detection of such flaws or other anomalies.

Implementations of the pipeline monitoring system can include multiple collar-transducer assemblies mounted in or on a pipeline (such as on a pipeline network in a hydrocarbon processing facility) to initiate the guided wave ultrasonic testing. The collar-transducer assemblies can be communicably coupled to a pulse/receiver device that energies the transducers to generate the acoustic waves through the piping. The pulse/receiver device can also collect or receive an acoustic waveform in response to the acoustic waves. Characteristics of the acoustic waveform can be analyzed by a control system to determine characteristics of a material anomaly on the pipeline, such as size, type and location of a defect. The acoustic waveform can also be analyzed to provide an estimate of a rate of material (for example, metal) loss during a specific time period of time which can be used as a proactive measure to set an appropriate contingency plans for pipeline operational continuity.

Implementations of pipeline monitoring systems and methods according to the present disclosure can attain a comprehensive, predictive real time corrosion mapping of a pipeline, along with advance corrosion related analysis using artificial intelligence and machine learning aspects of one or more pipeline characteristics. In some aspects, the pipeline monitoring system can be used for metallic pipelines, with the guided ultrasonic waves selected or configured based on the characteristics of the pipeline, such as by material type (for example, carbon steel, stainless steel, alloys of the same or other metal) and pipeline geometry (for example, outer diameter, inner diameter, cross-section shape, wall thickness and others). In some aspects, no couplant (in other words, a liquid layer on an outer surface of the pipeline to form a transmission medium for ultrasonic waves) to facilitate ultrasonic wave transmission between the transducers and the pipeline material.

Implementations of the pipeline monitoring system can provide significant improvement over conventional corrosion monitoring techniques, which often involve manually testing coupons insertable into the pipeline for corrosion. Indeed, current corrosion monitoring methods such as test coupons and on-stream inspection (OSI) are executed manually and may possess safety concerns. Further, conventional techniques are backward looking in that data are being optimized in monthly bases, as opposed to a predictive analysis (as explained more fully herein) provided by implementations according to the present disclosure. In addition, conventional techniques provide limited coverage among a piping system by focusing only on critical spots identified with localized corrosion (often by human operators). Thus, such techniques are subject to human errors due to mishandling during manual data collection at testing locations or at the laboratory during coupon's examination.

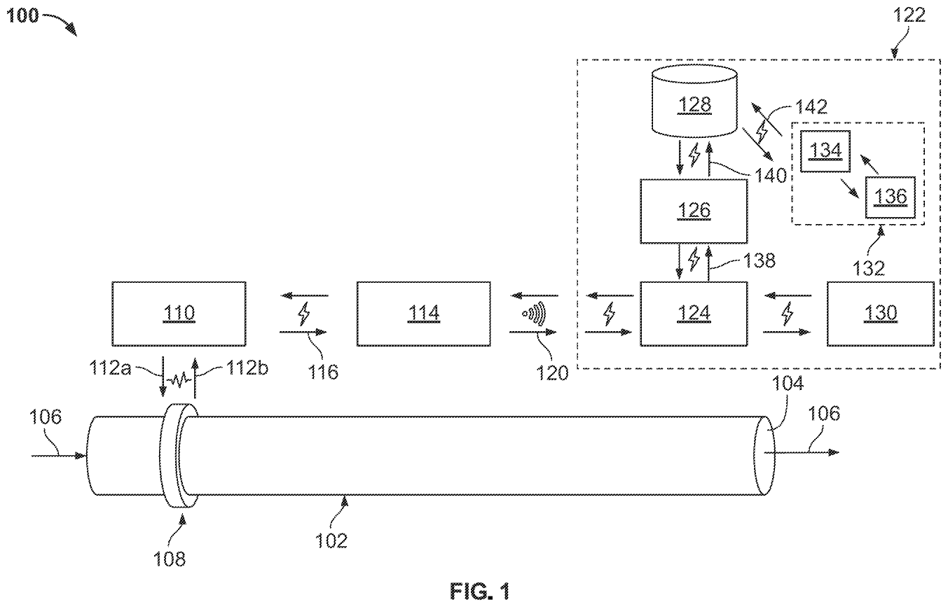

FIG. 1 is a schematic illustration of an example implementation of a pipeline monitoring system 100 according to the present disclosure. As illustrated, the system 100 can be installed on and used with a pipeline 102 that carries a fluid 106 through a bore 104 of the pipeline 102. In some aspects, the fluid 106 includes or is a hydrocarbon fluid (such as oil, gas, or multi-phase hydrocarbon fluid).

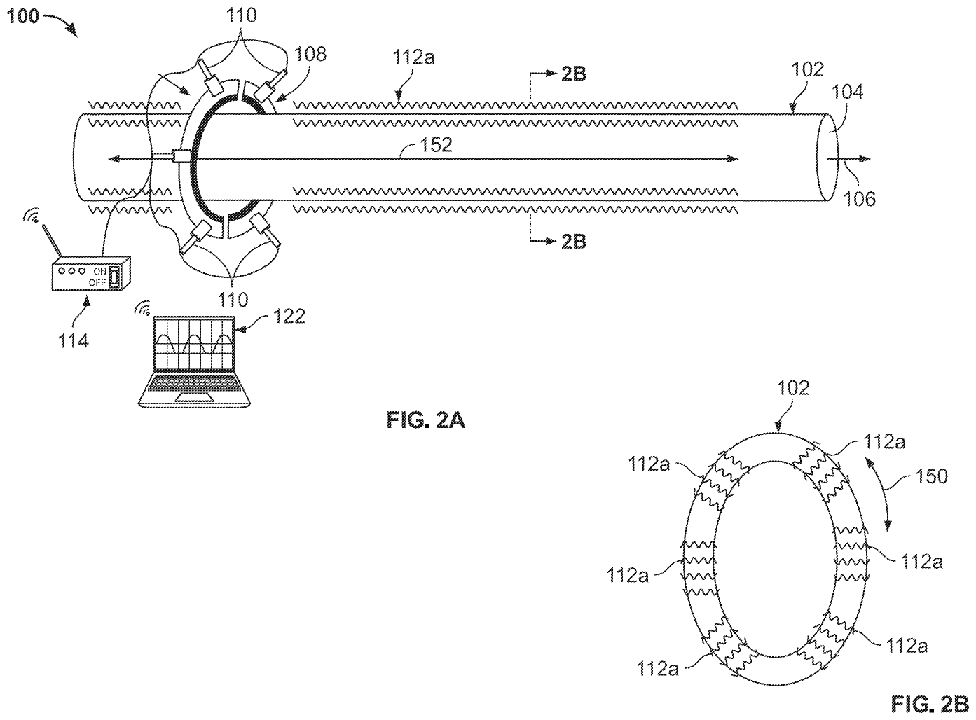

As shown, a collar 108 is mounted or installed on the pipeline 102 (such as about an entire circumference of the pipeline 102). The collar 108, in example aspects, can be a metallic or rubber (or other material) clamp ring that includes a hinge located at one point along the ring and a lock located at another point along the ring about 180 degrees from the hinge. The collar 108, as shown more fully in FIG. 2A, comprises a platform where transducers 110 are mounted and positioned in a balanced orientation about the pipeline 102 (for example, at equal, radial intervals about the circumference of the pipeline 102).

The transducers 110, as shown in FIG. 1, convert electrical signals 116 generated by a pulse/receiver device 114 into ultrasonic waves 112a, which flow or propagate through the pipeline 102 (as shown more fully in FIGS. 2A and 2B). In response, an acoustic waveform 112b travels back to the transducers 110 from the pipeline 102 (and provided, through the pulse/receiver device 114 to a control system 122 as explained more fully herein).

Although only one collar 108 and transducers 110 (collectively, a collar-transducer assembly) is shown in FIG. 1, there can be more than one and, in some aspects, many collar-transducer assemblies mounted on the pipeline 102. For example, within a pipeline 102 (or otherwise, a piping network), there can be many branches of piping that carry the fluid 106. Therefore, the collar-transducer assemblies can be installed at various locations in the pipeline 102 to ensure that the acoustic waves 112a (and reflected acoustic waveforms 112b) propagate and reflect through all, most, or some of the pipeline 102. In some aspects, a distance between collar-transducer assemblies on the pipeline 102 can be based at least in part on a strength (amplitude) or frequency (or both) of the acoustic waves 112a. In some aspects, the distance between collar-transducer assemblies (with each assembly installed at a unique location in the pipeline 102) is up to 50 meters. In locations of the pipeline 102 on which a collar-transducer assembly cannot be installed, manual on-site inspection techniques can be employed (with such output data provided along with the acoustic waveform 112b data for analysis as described herein).

The pulse/receiver device 114 contains or is electrically coupled to an electrical power source (for example, a grid or off grid source such as a battery) to generate electrical energy 116 to provide to the transducers 110. In turn, the transducers 110 generate the acoustic waves 112a from the electrical energy 116. In some aspects, the pulse/receiver device 114 also operates to alternate voltage and amperage when needed to, for example, change an amplitude or frequency (or both) of the acoustic waves 112a.

The control system 122 is communicably coupled (through wired or wireless signals 120) to the pulse/receiver device 114 to control operations of the pulse/receiver device 114, as well as analyze the acoustic waveform 112b to determine one or more material anomalies (corrosion, defects, or otherwise) in the pipeline 102. Generally, the control system 122 includes a control unit 124 for bi-directional communication with the pulse/receiver device 114, as well as a data processing unit 126 (with one or more hardware processors) that communicates to the control unit 124 through electrical (or optical) signals 138. The data processing unit 126 also communicates through electrical (or optical) signals 140 with a database 128. The database 128 can store data related to control of the pulse/receiver device 114, such as amplitudes and/or frequencies at which the acoustic waves 112a can be generated, as well as protocols and timing patterns at which the pulse/receiver device 114 can be operated to generate the electrical energy 116.

The control system 122, in this example, also includes an amplifier 130. In some aspects, amplifier 130 can operate to compensate for signal loss (for example of signal connection 120) that occurs during a transmission over long distances. As data travel, it experience attenuation which weakens the signal strength. The power amplifier 130 can be employed to amplify or strengthen the weakened signals and restore their power levels, ensuring reliable and accurate data streamlining. In some aspects, the power amplifier 130 functions to receive the electrical signals from the control unit 124 and amplify these electrical signals to a higher power level or amplitude for further transmission. The power amplifier 130 helps to overcome the signal loss and maintain the signal quality throughout the transmission path.

As shown in this example, the control system 122 also includes advanced data processing capabilities, such as an advanced data processing unit 132 that includes artificial intelligence (AI) and machine learning (ML) modules 134 and 136, respectively. The advanced data processing unit 132 communicates with the database 128 with electrical (or optical) signals 142. Generally, the advanced data processing unit 132 utilizes the AI module 134 and/or the ML module 136 to analyze and optimize predictive solutions from the feed of data from the system 100 (such as the acoustic waveform 112b data and anomaly determinations). Other data, such as on-stream inspection data of the pipeline 102 can be provided to the advanced data processing unit 132. Through the continuous or semi-continuous data provided by the system 100 or the on-stream inspection data (or both), the advanced processing unit 132 can provide output data for reliable services including, but not limited to, redefining equipment end of life calculations through furtherly detailed and more accurate anomaly (for example, corrosion) output data; setting an optimum contingency plan for events caused by corrosion or other anomalies; proposing more efficient operating style with less corrosion impact; and availing a predictive solution that helps minimize a risk of operational downsides in the future.

In example aspects according to the present disclosure, the pipeline monitoring system 100 can provide for one, some, or all of the following features: guided wave ultrasonic testing and scanning coverage, transducer control and functionality, pipeline surface preparation, and network connectivity. One, some, or all of these features can help assure the efficiency of the system 100 to provide a precise, real time analysis of the pipeline 102 for possible material anomalies. For example, a range of scanning coverage by the acoustic waves 112a, designated by far emitted signals/waves can travel longitudinally through the piping 102, is determined based on the capacity of the pulse/receiver 114. In some aspects, this capacity can vary with respect to the model of the pulse/receiver device 114. Transducer functionality can be maintained through regular calibration sessions along with periodic preventative maintenance program. Surface preparation pertains to what extent the outer surface of the pipeline 102 is cleaned and free of contaminations. Finally, network connectivity can confirm a streamline of data in between the pulse/receiver device 114 and the control system 122. Any potential network disconnect can impact the real time data optimization of the control system 122 to determine the material anomalies in the pipeline 102.

FIGS. 2A and 2B are schematic illustrations of the example implementation of a pipeline monitoring system 100 according to the present disclosure. FIG. 2A shows another view of at least a portion of the pipeline monitoring system 100, with a collar 108 and transducers 110 installed onto the collar 108 (which in turn, is installed around the circumference of the pipeline 102. As shown in this figure, the acoustic waves 112a can travel bi-directionally in parallel to a longitudinal axis 152 of the pipeline 102 (in other words, parallel to a direction of flow of the fluid 106). FIG. 2B shows a cross-section taken on the pipeline 102, which shows the acoustic waves 112a that are generated by transducers 110. As shown in FIG. 2B, due to the radial spacing of the transducers 110 about the pipeline 102, multiple acoustic waves 112a propagate through the pipeline 102 with each set of waves 112a radially spaced about the pipeline 102. As shown in this figure, a radial spacing 150 can separate radially adjacent acoustic waves 112a. In some aspects, the radial spacing 150 is equal or approximately equal (plus or minus a few degrees or so) between each pair of radially adjacent acoustic waves 112a.

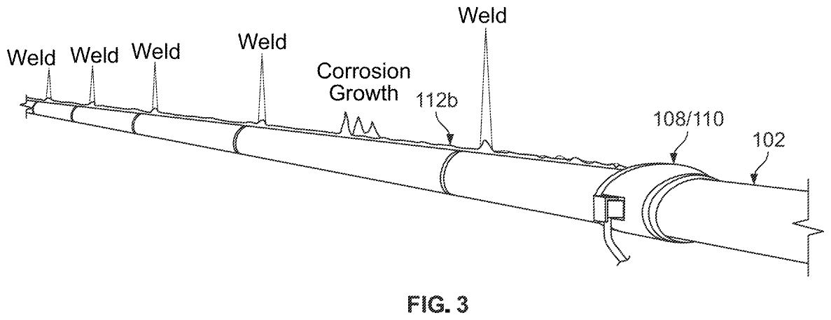

FIG. 3 is a schematic illustration of a portion of a piping network in which guided ultrasonic waves are propagated to monitor corrosion according to the present disclosure. As shown in this figure, a portion of the pipeline monitoring system 100 is illustrated and in operation. Here, a collar 108 and transducers 110 (collectively, the collar-transducers assembly) is mounted on the pipeline 102 at a particular location. The acoustic waveform 112b is schematically illustrated (reflected back to the collar-transducer assembly).

As shown schematically here, the acoustic waveform 112b can include changes in amplitude that indicate one or more material anomalies in the pipeline 102. For example, some changes in amplitude of the acoustic waveform 112b indicate anomalies in the form of welds between sections in the pipeline 102. While such “defects” may not be a concern, other changes in amplitude of the acoustic waveform 112b indicate anomalies in the form of corrosion growth as shown. Further, some changes in amplitude of the acoustic waveform 112b indicate anomalies in the form of thinner wall portions of the pipeline 102 due to corrosion (in the interior or exterior of the pipeline 102).

With reference to FIGS. 1, 2A, 2B, and 3, example operations of the pipeline monitoring system 100 can be implemented as follows. In some aspects, certain steps of the operations can be implemented by the control system 122 (for example, by software instructions stored in the database 128 and executed by the data processing unit 126 to control other components of the control system 122 or system 100, itself).

In some aspects, prior to real-time operation of the system 100 to determine one or more material anomalies, the system 100 can be installed on the pipeline 102 and calibrated. For example, one, some, or many collar-transducer assemblies can be installed at various, unique locations on the pipeline 102 (such as be installing the clamp ring portion of the collar 108 to the pipeline 102). At least one pulse/receiver device 114 (along with the transducers 110) can be be calibrated to confirm functionality. The calibration can be carried out on a particular or separate piping segment (for example, separate from the pipeline 102) that has fabricated artificial anomalies (for example, defects) of which once detected, the components are considered calibrated.

In some cases, the collar-transducer assemblies can be installed on portions of the pipeline 102 that are relatively clean and free of surface defects. Through the signal connection 120, the pulse/receiver device 114 is controlled by the control system 122. Prior to operation, an operator can enter information into the control system 122, such as, for example, material and geometry information of the pipeline 102 (or multiple segments of the pipeline 102 if different). The operator can then initiate operation of the system 100 through the control system 100.

During real-time operation, the collar-transducer assemblies are energized by the pulse/receiver device 114 (or multiple pulse/receiver devices 114) to generate the acoustic waves 112a. The generation of the acoustic waves 112a can occur periodically over a particular time duration, and even continuously during operation of the pipeline 102 to transport the fluid 106. In some aspects, the control system 122 controls the pulse/receiver device(s) 114 so that different frequencies or amplitudes (or both) are generated of the acoustic waves 112a.

Reflected acoustic waveform(s) 112b result from the generated acoustic waves 112a. Such reflected waveforms 112b can reflect to one or more collar-transducer assemblies on the pipeline 102 and transmitted to the control system 122. The control system 122 analyzes the reflected waveforms 112b (such as their amplitudes, frequencies, or both) to determine a location of one or more material anomalies in the pipeline 102.

In some aspects, the control system 112 (for example, through the advanced data processing unit 132) can create a model (such as a machine learning model) of the pipeline 102 with the locations of the determined material anomalies. This model can be updated over time, as, iteratively, more acoustic waves 112a (and thus more acoustic waveforms 112b) are generated (and are acquired). Thus, the model of the pipeline 102 can provide for a predictive solution for determining locations of material anomalies, such as corrosion or other defects, as well as possible, future defects or anomalies.

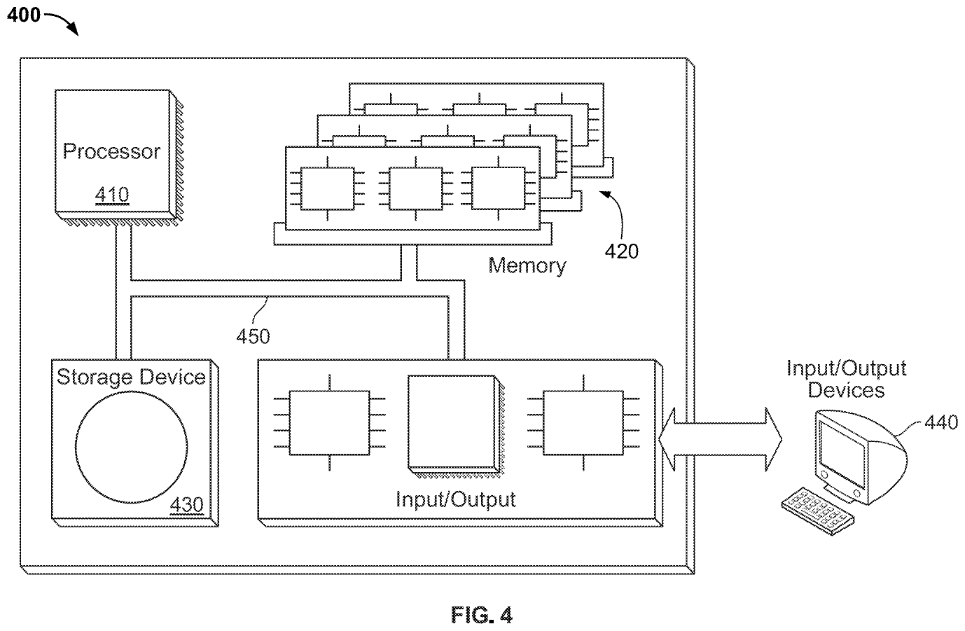

FIG. 4 is a schematic illustration of an example controller 400 (or control system) for a pipeline monitoring system. For example, the controller 400 can be used for the operations described previously, for example as or as part of the control system 122. For example, the controller 400 may be communicably coupled with, or as a part of, a pipeline monitoring system as described herein.

The controller 400 is intended to include various forms of digital computers, such as printed circuit boards (PCB), processors, digital circuitry, or otherwise that is part of a vehicle. Additionally, the system can include portable storage media, such as, Universal Serial Bus (USB) flash drives. For example, the USB flash drives may store operating systems and other applications. The USB flash drives can include input/output components, such as a wireless transmitter or USB connector that may be inserted into a USB port of another computing device.

The controller 400 includes a processor 410, a memory 420, a storage device 430, and an input/output device 440. Each of the components 410, 420, 430, and 440 are interconnected using a system bus 450. The processor 410 is capable of processing instructions for execution within the controller 400. The processor may be designed using any of a number of architectures. For example, the processor 410 may be a CISC (Complex Instruction Set Computers) processor, a RISC (Reduced Instruction Set Computer) processor, or a MISC (Minimal Instruction Set Computer) processor.

In one implementation, the processor 410 is a single-threaded processor. In another implementation, the processor 410 is a multi-threaded processor. The processor 410 is capable of processing instructions stored in the memory 420 or on the storage device 430 to display graphical information for a user interface on the input/output device 440.

The memory 420 stores information within the controller 400. In one implementation, the memory 420 is a computer-readable medium. In one implementation, the memory 420 is a volatile memory unit. In another implementation, the memory 420 is a non-volatile memory unit.

The storage device 430 is capable of providing mass storage for the controller 400. In one implementation, the storage device 430 is a computer-readable medium. In various different implementations, the storage device 430 may be a floppy disk device, a hard disk device, an optical disk device, a tape device, flash memory, a solid state device (SSD), or a combination thereof.

The input/output device 440 provides input/output operations for the controller 400. In one implementation, the input/output device 440 includes a keyboard and/or pointing device. In another implementation, the input/output device 440 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, for example, in a machine-readable storage device for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, solid state drives (SSDs), and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) or LED (light-emitting diode) monitor for displaying information to the user and a keyboard and a pointing device such as a mouse or a trackball by which the user can provide input to the computer. Additionally, such activities can be implemented via touchscreen flat-panel displays and other appropriate mechanisms.

The features can be implemented in a control system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include a local area network (“LAN”), a wide area network (“WAN”), peer-to-peer networks (having ad-hoc or static members), grid computing infrastructures, and the Internet.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

A number of implementations have been described. Nevertheless, it will be understood that various modifications may be made without departing from the spirit and scope of the disclosure. For example, example operations, methods, or processes described herein may include more steps or fewer steps than those described. Further, the steps in such example operations, methods, or processes may be performed in different successions than that described or illustrated in the figures. Accordingly, other implementations are within the scope of the following claims.

What is claimed is:

1. A pipeline monitoring system, comprising:
at least one collar configured to mount on a pipeline that transports a fluid;
a plurality of transducers coupled to the at least one collar and configured to output a plurality of ultrasonic waves that travel through the pipeline in at least one direction parallel to a direction of flow of the fluid in the pipeline;
at least one pulse receiver electrically coupled to the plurality of transducers and configured to generate electrical power from a power source; and
a control system communicably coupled to the pulse receiver and configured to perform operations comprising:
operating the at least one pulse receiver to transmit the generated electrical power to the plurality of transducers to output the plurality of ultrasonic waves;
receiving, through the plurality of transducers, feedback data that comprises at least one ultrasonic waveform; and
determining, based on the at least one ultrasonic waveform, a location on the pipeline that comprises a material anomaly.

2. The pipeline monitoring system of claim 1, wherein the at least one collar comprises a plurality of collars, each collar configured to mount on the pipeline at a unique location of the pipeline, and
the plurality of transducers comprises a plurality of sets of transducers, each set of transducers coupled to one of the plurality of collars.

3. The pipeline monitoring system of claim 2, wherein each unique location of the pipeline is 50 meters from adjacent unique locations of the pipeline.

4. The pipeline monitoring system of claim 2, wherein the operations comprise:
operating the at least one pulse receiver to transmit the generated electrical power to the plurality of sets of transducers to output the plurality of ultrasonic waves;
receiving, through the plurality of sets of transducers, feedback data that comprises the at least one ultrasonic waveform; and
determining, based on the at least one ultrasonic waveform, a plurality of locations on the pipeline that each comprise a particular material anomaly.

5. The pipeline monitoring system of claim 4, wherein the operations comprise:
generating a model of the pipeline that comprises the plurality of locations on the pipeline that each comprise the particular material anomaly;
performing successive iterations over a time duration of:
operating the at least one pulse receiver to transmit the generated electrical power to the plurality of sets of transducers to output the plurality of ultrasonic waves;
receiving, through the plurality of sets of transducers, feedback data that comprises the at least one ultrasonic waveform; and
determining, based on the at least one ultrasonic waveform, the plurality of locations on the pipeline that each comprise the particular material anomaly; and
updating the model of the pipeline with each successive iteration.

6. The pipeline monitoring system of claim 5, wherein the model comprises a machine learning model.

7. The pipeline monitoring system of claim 1, wherein one or more characteristics of the plurality of ultrasonic waves is selected, based on at least one of a pipeline material or a pipeline size, to cause the plurality of ultrasonic waves to travel through the pipeline in the at least one direction parallel to the direction of flow of the fluid in the pipeline.

8. The pipeline monitoring system of claim 7, wherein the one or more characteristics comprise at least one of amplitude or frequency.

9. The pipeline monitoring system of claim 1, wherein the at least one collar is configured to mount about an outer circumference of the pipeline, and the plurality of transducers are coupled to the least one collar at equally spaced radial intervals about the outer circumference.

10. The pipeline monitoring system of claim 1, wherein the at least one direction parallel to the direction of flow of the fluid in the pipeline comprises:
a first direction parallel to the direction of flow of the fluid in the pipeline; and
a second direction parallel to the direction of flow of the fluid in the pipeline and opposite the first direction.

11. The pipeline monitoring system of claim 1, wherein the material anomaly comprises corroded material of the pipeline.

12. The pipeline monitoring system of claim 1, wherein the fluid comprises a hydrocarbon fluid.

13. A method of monitoring a pipeline material, comprising:
operating at least one pulse receiver to transmit electrical power from a power source to a plurality of transducers coupled to at least one collar mounted on a pipeline that transports a fluid;
based on the transmitted electrical power from the at least one pulse receiver to the plurality of transducers, outputting a plurality of ultrasonic waves that travel through the pipeline in at least one direction parallel to a direction of flow of the fluid in the pipeline;
receiving, through the plurality of transducers, feedback data that comprises at least one ultrasonic waveform; and
determining, based on the at least one ultrasonic waveform, a location on the pipeline that comprises a material anomaly.

14. The method of claim 13, comprising:
operating the at least one pulse receiver to transmit electrical power from the power source to a plurality of sets of transducers, each set of transducers coupled to a particular collar of a plurality of collars mounted on a pipeline; and
based on the transmitted electrical power from the at least one pulse receiver to the plurality of sets of transducers, outputting a plurality of sets of ultrasonic waves that travel through the pipeline in the at least one direction.

15. The method of claim 14, comprising installing each of the plurality of collars on the pipeline at a unique location of the pipeline.

16. The method of claim 14, comprising:
receiving, through the plurality of sets of transducers, feedback data that comprises the at least one ultrasonic waveform; and
determining, based on the at least one ultrasonic waveform, a plurality of locations on the pipeline that each comprise a particular material anomaly.

17. The method of claim 16, comprising:
generating a model of the pipeline that comprises the plurality of locations on the pipeline that each comprise the particular material anomaly;
performing successive iterations over a time duration of:
operating the at least one pulse receiver to transmit the generated electrical power to the plurality of sets of transducers to output the plurality of ultrasonic waves;
receiving, through the plurality of sets of transducers, feedback data that comprises the at least one ultrasonic waveform; and
determining, based on the at least one ultrasonic waveform, the plurality of locations on the pipeline that each comprise the particular material anomaly; and
updating the model of the pipeline with each successive iteration.

18. The method of claim 17, wherein the model comprises a machine learning model.

19. The method of claim 13, comprising selecting one or more characteristics of the plurality of ultrasonic waves, based on at least one of a pipeline material or a pipeline size, to cause the plurality of ultrasonic waves to travel through the pipeline in the at least one direction parallel to the direction of flow of the fluid in the pipeline.

20. The method of claim 19, wherein the one or more characteristics comprise at least one of amplitude or frequency.

21. The method of claim 13, comprising:
mounting the at least one collar about an outer circumference of the pipeline; and
connecting the plurality of transducers to the least one collar at equally spaced radial intervals about the outer circumference.

22. The method of claim 13, wherein the at least one direction parallel to the direction of flow of the fluid in the pipeline comprises:
a first direction parallel to the direction of flow of the fluid in the pipeline; and
a second direction parallel to the direction of flow of the fluid in the pipeline and opposite the first direction.

23. The method of claim 13, wherein the material anomaly comprises corroded material of the pipeline.

24. The method of claim 13, wherein the fluid comprises a hydrocarbon fluid.
